(19) United States
(12) Patent Application Publication
(10) Pub. No.: US 2011/0034257 A1
(43) Pub. Date: Feb. 10, 2011

(54) PROTECTIVE SHEATH FOR CABLE

(76) Inventor: Yuan-hung Wen, Chang Hua Hsien (TW)

Correspondence Address: Chien-Hui Su, P. O. Box 70-121 Taichung, Taichung City, 40899, TW

(21) Appl. No.: 12/747,519

(22) PCT Filed: May 27, 2008
(86) PCT No.: PCT/CN08/71105

§ 371 Date: Jun. 11, 2010

(30) Foreign Application Priority Data
Mar. 11, 2008 (CN) 200810052405.4

(51) Int. Cl. F16C 1/26

(52) U.S. Cl. 464/173

(57) ABSTRACT

A protective sheath for cable includes a series of casings. Each casing has a first end and a second end. Each casing includes a recess defined in the first end and having an inner diameter which is equal to or greater than an outer diameter of the second end. A groove is defined in the recess. A passageway is axially defined in each casing. A washer is disposed in the groove and has a through hole defined therein for communicating with the passageway. A cable passes through the through hole of each washer to be gripped and protected by each washer.

### BACKGROUND OF THE INVENTION

1. Field of the Invention

The present invention relates to a protective sheath having a series of casings, particularly to each casing having a washer received therein for gripping and protecting a cable.

2. Description of Related Art

It is very important to ride a bicycle with well-designed bicycle brake cables; in the past, the brake cables are exposedly disposed on the bicycle and are drenched and worn when riding. Even the brake cables which are made of steel would get rusty. Therefore, the manufacturers usually use a flexible plastic tube to enclose the brake cable for attaining a protective effect, and the flexible plastic tube is able to be bent into different curved configurations for satisfying a particular bicycle.

However, when the flexible plastic tube is used for a long time, the plastic tube would gradually lose its elasticity. The plastic tube becomes fragile and is easily detached from the brake cable, such that the plastic tube would be broken and fail to protect the brake cable. And the plastic tube would be easily broken when the plastic tube with the brake cable is frequently bent. It may cause the brake cable exposed out of the plastic tube. After then, dust may get into the plastic tube and affect the movement of the brake cable. Moreover, the plastic tub has a fixed length corresponding to the brake cable, and the length of the plastic tube can't be adjusted to fit the brake cable with a different length.

U.S. Pat. No. 6,250,175 disclose an improved pull cable system that includes a cable for transmitting a tensile force, a flexible tube for accommodating the cable, and a casing enclosing the tube for absorbing a pressure force. The casing is composed of a plurality of elements which are joined to one another and have a continuous axial passageway axially defined in the series-connected elements. Each element has a first end and a second end. The first end of each element is movably connected to the second end of the adjacent element. The elements are configured in successive disposition, such that the passageway can correspondingly have different arched formations by the movement of the series-connected elements.

But, the brake cable shown in the prior arts is still enclosed by the flexible tube for avoiding the brake cable rubbing against the casing. The flexible tube would become fragile and be easily detached from the cable, such that the detached flexible tube would block in the casing and affect the pull movement of the brake cable. Furthermore the flexible tube is usually made with plastic in addition to easily enclose the brake cable, and it costs a lot for manufacturing. The other conventional casing systems only disclose that the casing has two ends with different calibers for coupling to one another. It is very easy to loose and it couldn't provide a stably connecting effect for joining one to each other.

The present invention has arisen to mitigate and/or obviate the disadvantages of the conventional casing system.

### SUMMARY OF THE INVENTION

Accordingly, the main object of the present invention is to provide a better protective sheath having a stable connection of each casing and a wider bending angle, and the present invention can avoid using the plastic tube to enclose around the brake cable.

To achieve the above objectives, the present invention provides a protective sheath for cable comprising a series of casings which are axially coupled to one another. Each casing has a first end and a second end which are opposite to each other. Each casing comprises a recess defined inside the first end thereof The recess of the first end has an inner surface which is formed in a concave shape. The second end of each casing has an outer surface which is formed in an approximately spherical shape. The inner surface of the recess has a diameter being equal to or greater than a diameter of the outer surface of the second end. A groove is defined in the recess of the first end. Each casing has a passageway axially defined therethrough and communicating the first end with the second end of each casing. The passageway has an outwardly flared inner surface which is located near the second end. A washer is flexible and is received in the groove. The washer has a through hole defined therein for communicating with the passageway. The through hole has an inner diameter being less than an inner diameter of the passageway.

Accordingly, the shape of the outer surface of each second end corresponds to the shape of the inner surface of each recess. The second end of each casing is swivelably inserted into the recess of the first end of the adjacent casing, such that the casings are coupled to one another and form a continuously series-connected protective sheath for admitting a cable. Each washer would deform, and the cable is allowed to pass through the through hole of each washer and the passageway of each casing. The cable is gripped and protected by each washer.

Further benefits and advantages of the present invention will become apparent after a careful reading of the detailed description with appropriate reference to the accompanying drawings.

### BRIEF DESCRIPTION OF THE DRAWINGS

FIG. 1 is a cutaway perspective view of a preferred embodiment of a protective sheath for cable in accordance with the present invention;

FIG. 2 is a partial perspective view of a casing of the preferred embodiment of the protective sheath for cable in accordance with the present invention;

FIG. 3 is an operational and cross-sectional view of the preferred embodiment of the protective sheath for cable in accordance with the present invention;

FIG. 4 is an operational and partial perspective view of the preferred embodiment of the protective sheath for cable in accordance with the present invention; and

FIG. 5 is a cutaway view of a second embodiment of the protective sheath for cable in accordance with the present invention.

### DETAILED DESCRIPTION OF THE INVENTION

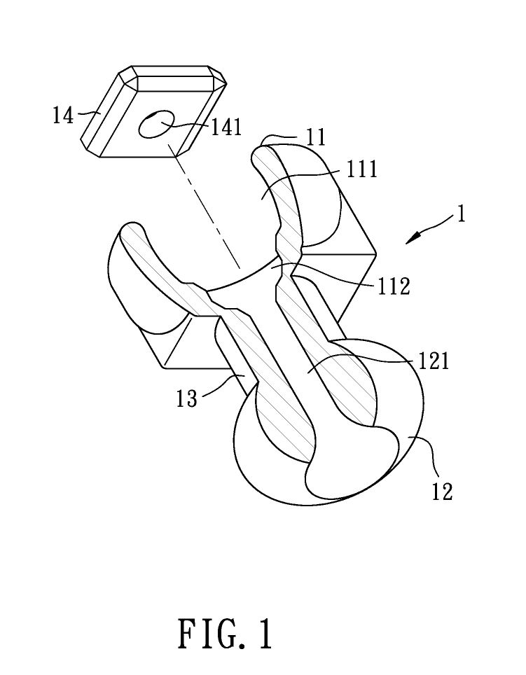

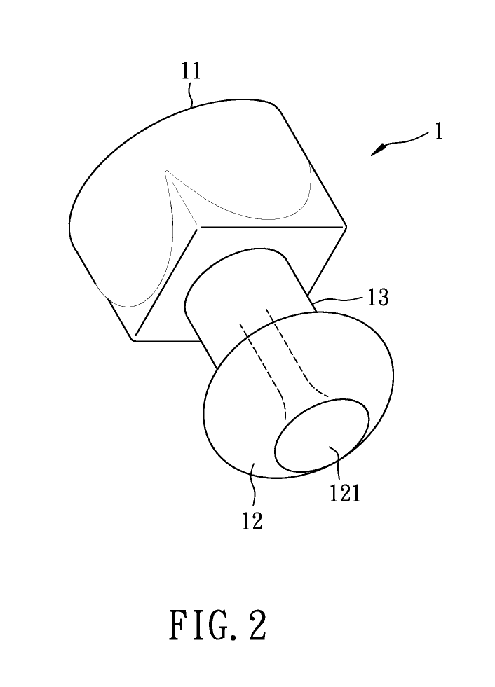

Referring to the drawings and initially to FIGS. 1-4, a protective sheath for cable in accordance with the present invention comprises a series of casings 1 which are axially coupled to one another. Each casing 1 has a first end 11 and a second end 12 which are opposite to each other. An outer diameter of the first end 11 is greater than an outer diameter of the second end 12. Each casing 1 has a neck portion 13 formed between the first end 11 and the second end 12. An outer diameter of the neck portion 13 is less than the outer diameter of the first end 11 and the outer diameter of the second end 12.

Each casing 1 comprises a recess 111 defined in the first end 11 thereof The recess 111 of the first end 11 has an inner surface which is formed in a concave shape. The second end 12 of each casing 1 has an outer surface which is formed in an approximately spherical shape for corresponding to the shape of the inner surface of the recess 111. The inner surface of the recess 111 has a diameter being equal to or greater than the diameter of the outer surface of the second end 12, such that the second end 12 of each casing 1 can be inserted into the recess 111 of the first end 11 of the adjacent casing 1.

A groove 112 is axially defined in a bottom of the recess 111 and has a quadrate inner surface. A washer 14 is flexible and has a quadrate shape for correspondingly receiving in the groove 112. The washer 14 has a through hole 141 centrally defined therein. Each casing 1 has a passageway 121 axially defined in a bottom of the groove 112 and axially extending through the neck portion 13. The passageway 121 communicates the first end 11 with the second end 12 of each casing 1. The passageway 121 which is located near the second end 12 has an inner surface outwardly formed into a flared shape, whereby an inner diameter of the passageway 121 near the first end 11 is less than the inner diameter of the passageway 121 near the second end 12. The through hole 141 of the washer 14 communicates with the passageway 121 as the washer 14 is received in the groove 112. An inner diameter of the through hole 141 is less than the inner diameter of the passageway 121 near the first end 11.

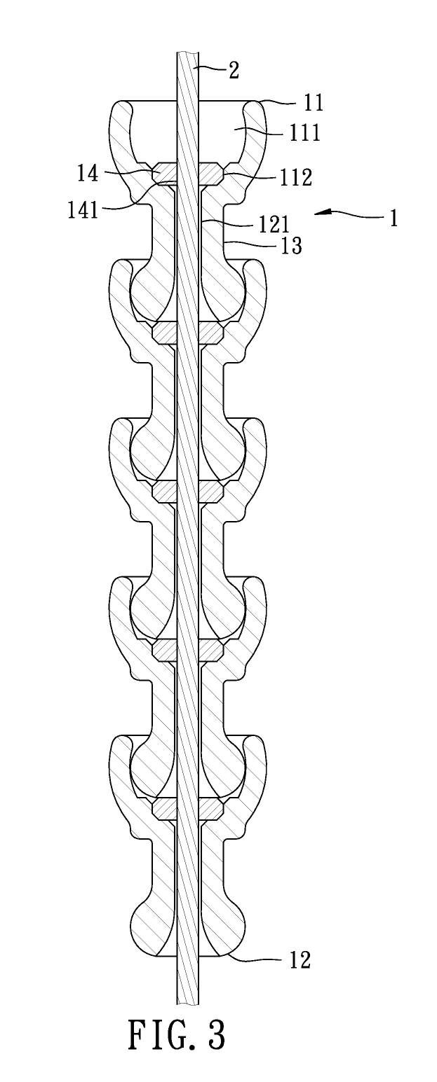

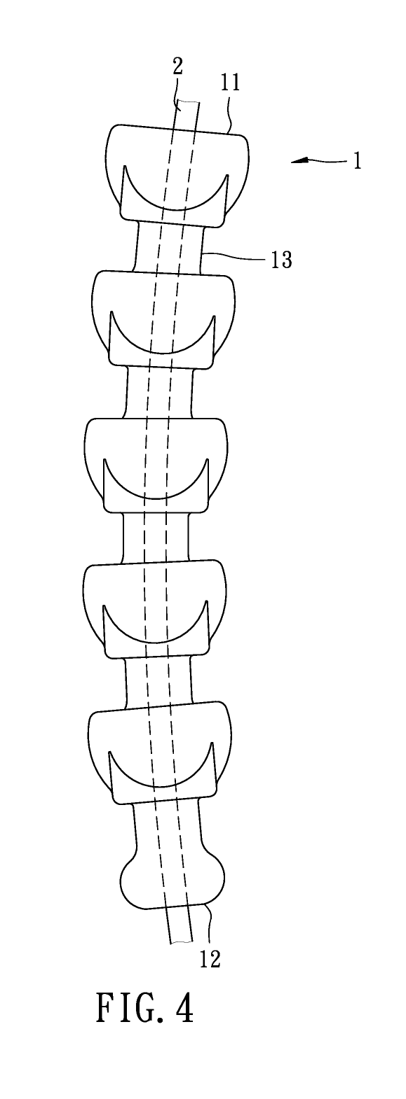

As shown in FIGS. 3-4, the shape of the outer surface of each second end 12 corresponds to the shape of the inner surface of each recess 111. Each washer 14 is received in the groove 112 of each casing 1. The second end 12 of each casing 1 is completely and swivelably inserted into the recess 111 of the first end 11 of the adjacent casing 1. The neck portion 13 of each casing 1 is partially received in the recess 111 of the first end 11 of the adjacent casing 1, wherein the casings 1 are coupled to one another and form a continuously and securely series-connected protective sheath for admitting a cable 2. The through hole 141 of the flexible washer 14 has an inner diameter being less than an outer diameter of the cable 2. Each washer 14 would deform, and the cable 2 compressedly passes through the through hole 141 of each washer 14 and the passageway 121 of each casing 1, such that each washer 14 tightly grips the cable 2. When the cable 2 surrounded by the casings 1 is operated to slide along the passageway 121 of each casing 1, the cable 2 would be protected by each washer 14 and is avoided from rubbing against the casings 1.

The approximately spherical outer surface of each second end 12 is swivelably coupled to the concave inner surface of the recess 111 of the adjacent casing 1. The neck portion 13 which has the outer diameter being less than the outer diameter of the second end 12 is partially received in the recess 111 of the first end 11 of the adjacent casing 1. Accordingly, the second end 12 is able to have a wide swiveling angle relative to the recess 111. The cable 2 is able to be correspondingly bent in a wide angle with the series-connected casings 1. The flared inner surface of the passageway 121 which is located near the second end 12 provides less limitation and diminishes a friction between the casings 1 and the cable 2 when the protective sheath is bent. In addition, a connection between each casing 1 is reinforced and stabilized.

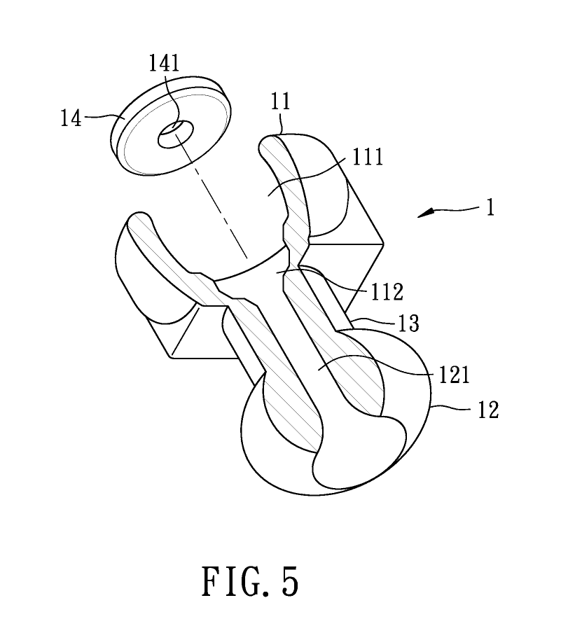

With reference to FIG. 5, it shows a second embodiment of the protective sheath for cable in accordance with the present invention. The elements and effects of the second embodiment which are the same with the preferred embodiment are not described, only the differences are described. In this embodiment, the groove 112 has a circular inner surface. The washer 14 is flexible and has a circular shape for correspondingly receiving in the groove 112.

Although the invention has been explained in relation to its preferred embodiment, it is to be understood that many other possible modifications and variations can be made without departing from the spirit and scope of the invention as hereinafter claimed.

1. A protective sheath for cable comprising:
a series of casings coupled in series with one another, each casing comprising a first end formed thereon, a second end formed thereon and located opposite to the first end, and a neck portion disposed between the first end and the second end; the first end having a recess defined therein, the recess having an inner surface formed in a concave shape, a groove defined in a bottom of the recess; the second end having an outer surface formed in an approximately spherical shape, the recess having an inner diameter being equal to or greater than an outer diameter of the second end for correspondingly receiving the second end of the adjacent casing; the neck portion having an outer diameter being less than the outer diameter of the second end;
a passageway an axially defined therein and extending from a bottom of the groove to the second end for communicating the first end with the second end, an inner diameter of the passageway near the recess being less than an inner diameter of the passageway near the second end, the passageway located near the second end having an inner surface outwardly formed into a flared shape; and
a washer disposed in the groove and having a through hole defined therein for communicating with the passageway, the through hole having an inner diameter being less than an inner diameter of the passageway, the washer being flexible;
wherein the second end of each casing is completely and swivelably inserted into the recess of the first end of the adjacent casing, the neck portion of each casing partially received in the recess of the first end of the adjacent casing, the casings coupled to one another and forming a continuously series-connected protective sheath for admitting a cable, the cable passing through the through hole of each washer to be gripped and protected by each washer elastic cushion.

2. The protective sheath for cable as claimed in claim 1, wherein the washer is in a quadrate shape and the groove has a corresponding shape for receiving the washer.

3. The protective sheath for cable as claimed in claim 1, wherein the washer is in a circular shape and the groove has a corresponding shape for receiving the washer.

4. (canceled)

5. (canceled)

6. (canceled)

7. (Canceled)
